(19) United States
(12) Patent Application Publication
(10) Pub. No.: US 2015/0211262 A1
(43) Pub. Date: Jul. 30, 2015

(54) Bicycle and Lock for Deterring and Preventing Theft

(71) Applicant: Kwan Yiu Leung, Shatin (HK)

(72) Inventor: Kwan Yiu Leung, Shatin (HK)

(21) Appl. No.: 14/166,758

(22) Filed: Jan. 28, 2014

(51) Int. Cl. E05B 71/00; G01H 17/00; F41H 13/00

(52) U.S. Cl. CPC E05B 71/00; F41H 13/0018; G01H 17/00

(57) ABSTRACT

According to embodiments of the invention, systems, devices and/or methods are provided for preventing and deterring theft of a park and/or locked bicycle. Various embodiments of the invention implement several novel features, including, in one embodiment, a bicycle that includes electric circuitry associated with a locking component which, when activated, generates an electrical current waveform sufficient to apply an electrical shock to a person who is trying to misappropriate the bicycle by attempting to break the lock and/or move the bicycle. A radio-frequency identification system may be employed to detect whether the person tampering with the bicycle is the owner of the bicycle.

### FIELD OF THE INVENTION

This invention is generally related to bicycles. More specifically, this invention relates to an improved bicycle lock with multiple theft deterring features.

### BACKGROUND OF THE INVENTION

Bicycle theft is a long-standing and serious problem for bicycle owners. The need for an effective theft deterrent has led to the design of many different bicycle locks and locking systems. One of the most popular bicycle locks is a flexible cable looped at each end and secured with a padlock. The cable is usually snaked around part of the bicycle frame and sometimes through the front wheel and around a bicycle rack, lamp post or other fixed object. The cable is secured with a padlock through the end loops. Some cable locks use an in-line lock integral to the cable instead of the padlock with looped ends.

While these types of cable locks are inexpensive and uncomplicated, they have several disadvantages. First, because these cable locks are not tethered to the bicycle, they can be lost. In fact, I first began working on a new locking system because my son kept losing his cable. Second, cables and locks must be stored apart from the bicycle, in a saddle bag or backpack for example, or wound around the bicycle frame. In either case, the cable and lock must be unpacked or unwound or both to lock the bicycle. Self-coiling cables present added difficulties—it is often a struggle to unwind the cable from the frame, get it straight enough to thread through the frame and front wheel and then around the bike rack and locked. Also, cable locks stored wound around the bicycle frame are generally not considered aesthetically pleasing, particularly for the newer ultra-high tech way expensive bicycles decked out in super-duper high definition color graphics.

While several types of these locks can withstand bolt cutters, they are typically no match for gas or electric power tools. Thus, there exists a need in the art for a bicycle and/or a bicycle lock which deters anyone from trying to break or cut through the lock in the first place, thereby preventing bicycle theft.

### SUMMARY OF THE INVENTION

According to embodiments of the invention, systems, methods and devices are directed to a bicycle and/or a bicycle cable locking system that helps overcome some of the disadvantages of conventional cable locking systems. Various embodiments of the invention implement several novel features, including, in one embodiment, a bicycle is provided that includes electric circuitry further included in a locking component which, when activated, generates an electrical current waveform which has a relatively high voltage that can induce an electric shock to a person who is trying to misappropriate the bicycle by attempting to break the anchoring member.

In an embodiment of the disclosed invention, a theft-avoidance bicycle and lock is provided. The bicycle may have one or more of the following components: a) a frame structure; b) a locking component physically associated with the frame structure; c) an anchoring member having two ends, a first end connectable to the frame structure via the locking component and a second end connectable to a fixture; d) a vibration detector, which includes a gyroscope; and e) an electric circuitry included in the locking component which, when activated, generates an electrical current which has a voltage that can induce an electric shock to a person attempting to break the anchoring member.

The electric circuitry is activated to generate the electric shock to the person when one or more of the following conditions are met: a) the locking component is physically engaged to the bicycle and the anchoring; b) vibration is detected by the vibration detector when the bicycle is parked; and c) a user of the bicycle is outside a vicinity of the bicycle as determined by an associated radio-frequency identification system. Still further, the electrical circuitry may notify the user via a smart device instantaneously when the parked bicycle is being moved. The notification may contain data relevant to the bicycle, such as a measurement of the electrical current or location of the bicycle.

In further embodiments the electric circuitry may be deactivated when the user is detected within the vicinity of the bicycle. The radio-frequency identification system may employ a radio-frequency transmitter disposed on the bicycle and a radio-frequency receiver carried by a user of the bicycle. The radio-frequency identification system may be used to deactivate the electrical circuitry when the bicycle is being used by the user.

In another embodiment of the disclosed technology, a method is used for deterring theft of a bicycle. The method is carried out, not necessarily in the following order, by: a) providing a bicycle with framework having an electrical circuit disposed therein; b) detecting, using an accelerometer disposed on the bicycle, that the bicycle is being moved; c) determining, using a radio-frequency transmitter disposed on the bicycle, that an associated radio-frequency identification tag associated with a user is not within a vicinity of the bicycle; d) generating an electrical current throughout the framework of the bicycle, wherein the electrical current has a voltage sufficient to inflict slight pain on a human; and e) notifying the user when an electrical current has been generated.

The notification may be a text message sent to a mobile device associated with the user. The notification may contain data relevant to the bicycle, such as a measurement of the electrical current or location of the bicycle.

In a further embodiment of the disclosed technology, a theft-avoidance bicycle for protecting against theft while the bicycle is parked is provided. The bicycle may have one or more of the following components: a) a frame structure; b) a locking component physically associated with the frame structure; an anchoring member having two ends, a first end connectable to the frame structure via the locking component and a second end connectable to a fixture, which includes a light post; c) a vibration detector, which includes a gyroscope; d) a warning signal to indicate that the bicycle is being charged and can cause damage to a person who touches the bicycle; and e) an electric circuitry included in the locking component which, when activated generates the warning signal is displayed and an electrical voltage waveform which has a relatively high voltage that can induce an electric shock to a person who is trying to misappropriate the bicycle by attempting to break the anchoring member by any means, including tweezers.

The electric circuitry would be activated and its associated circuit should be in a closed circuit so that a current can be applied to generate the electric shock to the person who is trying to misappropriate the bicycle, when all following conditions are met: a) the locking component is physically engaged to the bicycle, which suggests that the bicycle is being parked and the anchoring member is being connected to the fixture; b) vibration is being detected by the vibration detector or gyroscope unexpectedly, which suggests that the bicycle is possibly being misappropriated by someone improperly when parked; and c) a user of the bicycle is outside vicinity of the bicycle, which eliminates a possibility that the vibration detected is caused by the user; determination of the user being outside the vicinity of the bicycle can be achieved by using radio frequency emitters and tags.

The electric circuitry would be deactivated and its associated circuit should be switched from a closed circuit to an open circuit to prevent the electric shock from applying to the user of the bicycle mistakenly, when the user is found within the vicinity of the bicycle, because it would be unnecessary to protect the bicycle from being stolen if the user is within a certain distance from the bicycle, while otherwise might cause the electric shock to the user of the bicycle. In which case the electric circuitry would notify the user via a smart device instantaneously when the parked bicycle is being moved when the move is detected by the vibrator detector or gyroscope, the notification includes how much current flows out, which is a good indicator as to whether the move is caused by a human being when considering resistance of the underlying object; and c) the electric circuitry would remain deactivated and its associated circuit would remain in an open circuit to prevent the electric shock from applying to the user of the bicycle mistakenly, when the bicycle is still in use by the user so that the user would be safe to use the bicycle.

It is, therefore, an objective of the disclosed invention to provide systems, devices and/or methods for preventing and deterring theft of a park and/or locked bicycle.

In accordance with these and other objects which will become apparent hereinafter, the invention will now be described with particular reference to the drawings.

### BRIEF DESCRIPTION OF THE DRAWINGS

FIG. 1 is an elevation view of a bicycle and lock according to an embodiment of the present invention.

FIG. 2 is a high-level block diagram of a microprocessor device that may be used to carry out the disclosed technology.

### DETAILED DESCRIPTION

According to embodiments of the invention, systems, methods and devices are directed to a bicycle and/or a bicycle cable locking system that helps overcome some of the disadvantages of conventional cable locking systems. Various embodiments of the invention implement several novel features, including, in one embodiment, a bicycle that includes electric circuitry further included in a locking component which, when activated, generates an electrical current waveform which has a relatively high voltage that can induce an electric shock to a person who is trying to misappropriate the bicycle by attempting to break an anchoring member.

Referring now to the figures, systems, methods and devices are provided for preventing and deterring theft of a park and/or locked bicycle. In an embodiment of the disclosed invention, a theft-avoidance bicycle and lock is provided. The bicycle may have one or more of the following components: a) a frame structure; b) a locking component physically associated with the frame structure; c) an anchoring member having two ends, a first end connectable to the frame structure via the locking component and a second end connectable to a fixture; d) a vibration detector, which includes a gyroscope; and e) an electric circuitry included in the locking component which, when activated, generates an electrical current which has a voltage that can induce an electric shock to a person attempting to break the anchoring member.

The electric circuitry is activated to generate the electric shock to the person when one or more of the following conditions are met: a) the locking component is physically engaged to the bicycle and the anchoring; b) vibration is detected by the vibration detector when the bicycle is parked; and c) a user of the bicycle is outside a vicinity of the bicycle as determined by an associated radio-frequency identification system. Still further, the electrical circuitry may notify the user via a smart device instantaneously when the parked bicycle is being moved. The notification may contain data relevant to the bicycle, such as a measurement of the electrical current or location of the bicycle.

In further embodiments the electric circuitry may be deactivated when the user is detected within the vicinity of the bicycle. The radio-frequency identification system may employ a radio-frequency transmitter disposed on the bicycle and a radio-frequency receiver carried by a user of the bicycle. The radio-frequency identification system may be used to deactivate the electrical circuitry when the bicycle is being used by the user.

In another embodiment of the disclosed technology, a method is used for deterring theft of a bicycle. The method is carried out, not necessarily in the following order, by: a) providing a bicycle with framework having an electrical circuit disposed therein; b) detecting, using an accelerometer disposed on the bicycle, that the bicycle is being moved; c) determining, using a radio-frequency transmitter disposed on the bicycle, that an associated radio-frequency identification tag associated with a user is not within a vicinity of the bicycle; d) generating an electrical current throughout the framework of the bicycle, wherein the electrical current has a voltage sufficient to inflict slight pain on a human; and e) notifying the user when an electrical current has been generated

The notification may be a text message sent to a mobile device associated with the user. The notification may contain data relevant to the bicycle, such as a measurement of the electrical current or location of the bicycle.

In a further embodiment of the disclosed technology, a theft-avoidance bicycle for protecting against theft while the bicycle is parked is provided. The bicycle may have one or more of the following components: a) a frame structure; b) a locking component physically associated with the frame structure; an anchoring member having two ends, a first end connectable to the frame structure via the locking component and a second end connectable to a fixture, which includes a light post; c) a vibration detector, which includes a gyroscope; d) a warning signal to indicate that the bicycle is being charged and can cause damage to a person who touches the bicycle; and e) an electric circuitry included in the locking component which, when activated generates the warning signal is displayed and an electrical voltage waveform which has a relatively high voltage that can induce an electric shock to a person who is trying to misappropriate the bicycle by attempting to break the anchoring member by any means, including tweezers.

The electric circuitry would be activated and its associated circuit should be in a closed circuit so that a current can be applied to generate the electric shock to the person who is trying to misappropriate the bicycle, when all following conditions are met: a) the locking component is physically engaged to the bicycle, which suggests that the bicycle is being parked and the anchoring member is being connected to the fixture; b) vibration is being detected by the vibration detector or gyroscope unexpectedly, which suggests that the bicycle is possibly being misappropriated by someone improperly when parked; and c) a user of the bicycle is outside vicinity of the bicycle, which eliminates a possibility that the vibration detected is caused by the user; determination of the user being outside the vicinity of the bicycle can be achieved by using radio frequency emitters and tags.

The electric circuitry would be deactivated and its associated circuit should be switched from a closed circuit to an open circuit to prevent the electric shock from applying to the user of the bicycle mistakenly, when the user is found within the vicinity of the bicycle, because it would be unnecessary to protect the bicycle from stolen if the user is within a certain distance from the bicycle, while otherwise might cause the electric shock to the user of the bicycle. In which case the electric circuitry would notify the user via a smart device instantaneously when the parked bicycle is being moved when the move is detected by the vibrator detector or gyroscope, the notification includes how much current flows out, which is a good indicator as to whether the move is caused by a human being when considering resistance of the underlying object; and c) the electric circuitry would remain deactivated and its associated circuit would remain in an open circuit to prevent the electric shock from applying to the user of the bicycle mistakenly, when the bicycle is still in use by the user so that the user would be safe to use the bicycle.

In embodiments, a radio frequency identification system is used to detect whether the user is in the vicinity of the bicycle. Radio frequency identification (“rfid”) tagging is a known method of identification. An information carrying device, or receiver, functions in response to a coded radio frequency (herein “RF”) signal transmitted from a base station or reader. The RF carrier signal reflects from the receiver and can be demodulated to recover information stored in the receiver. The receiver typically includes a semiconductor chip having RF circuits, logic, and memory, as well as an antenna. Various receiver structures, circuits, and programming protocols are known in the art.

RF systems typically have three components: (1) a tag or receiver (the item being identified), (2) an interrogator or reader, and (3) a data managing medium (typically including cabling, computers, and software which tie together the tags and interrogators into a useful solution). RF products are typically designed to detect receivers when they pass within a predefined range of the reader.

There are generally two types of RF receivers known in the art: passive RF receivers and active RF receivers. Passive RF receivers, unlike active ones, do not require a battery in order to transmit a RF signal frequency. Instead, passive RF receivers rely on an external source to provoke signal transmission. The RF reader transmits the operating power for these receivers. As a result, such passive RF systems generally have a detection range of limited to a couple meters. However, passive RF receivers may generally be manufactured to be smaller in size than active RF receivers due to the absence of a battery.

Most passive rfid systems work as follows. A reader emits an electromagnetic field for the purpose of powering the receiver. A coil in the receiver is powered by the electromagnetic field, causing the receiver's circuitry to “wake up.” The receiver uses this power to send an identifying signal back to the interrogator. Either type of rfid tag may be employed by the present technology.

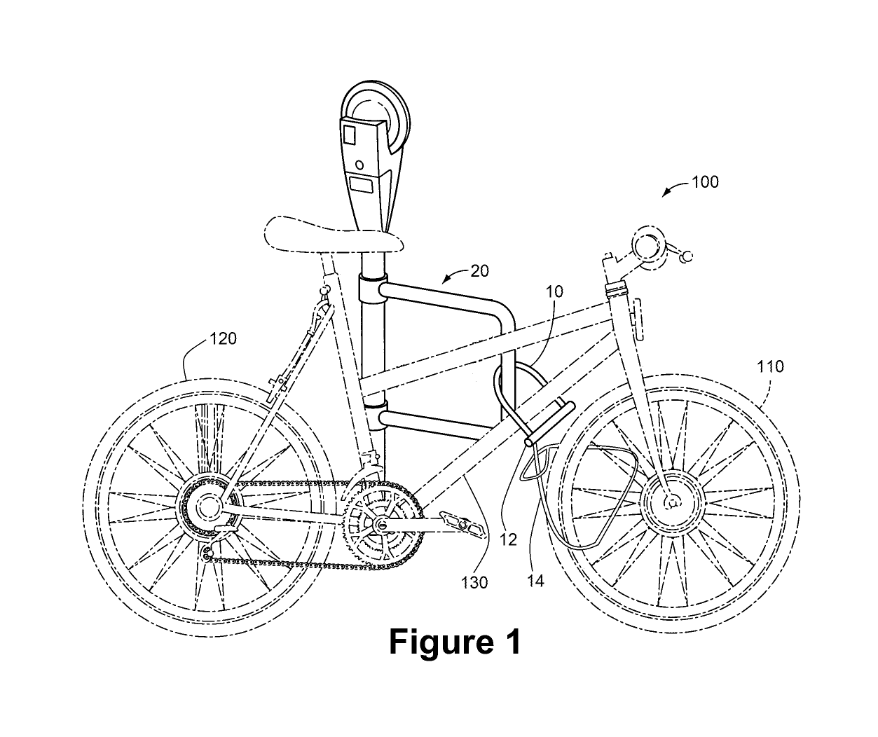

FIG. 1 is an elevation view of a bicycle 100 and lock according to an embodiment of the present invention. The bicycle 100 is shown locked to a post 20. The disclosed system and method may be used no matter where the bicycle 100 is locked. The lock has an anchoring member 10 and a locking component 12. The lock may also have a tether 14 for further security. For example, the tether 14 may be tied through a front wheel 110 of the bicycle for added security. Alternatively, the tether 14 may be tied through the rear wheel 120. The bicycle 100 has a frame 130 within which various electrical components (not shown) may be disposed. The RFID transmitter, electrical circuit, and any other network components may be disposed within the hollow metal bars of the frame 130. Likewise, the frame 130, as well as other metal parts of the bicycle 100, may be used for conducting the electrical shock to a potential thief tampering with the bicycle. Thus, the shock may be transferred to the potential thief whenever any portion of their body makes contact with the frame 130 or any other metal portions of the bicycle 100.

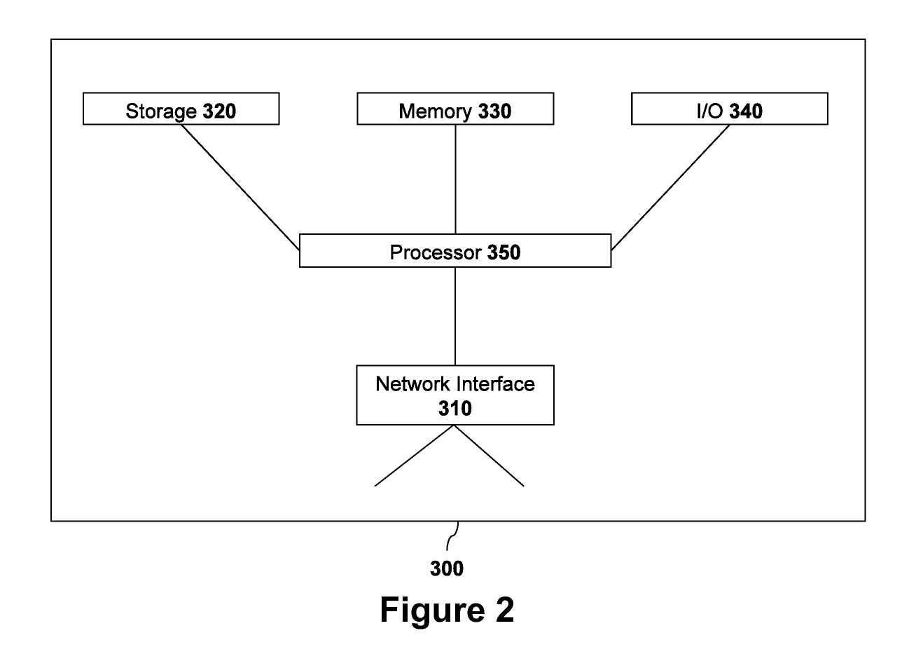

FIG. 2 is a high-level block diagram of a microprocessor device that may be used to carry out the disclosed technology. The device 300 may or may not be a computing device. The device 300 comprises a processor 350 that controls the overall operation of a computer by executing the reader's program instructions which define such operation. The device's program instructions may be stored in a storage device 320 (e.g., magnetic disk, database) and loaded into memory 330 when execution of the console's program instructions is desired. Thus, the device's operation will be defined by its program instructions stored in memory 330 and/or storage 320, and the console will be controlled by the processor 350 executing the console's program instructions.

The device 300 may also include one or a plurality of input network interfaces for communicating with other devices via a network (e.g., the internet). The device 300 further includes an electrical input interface for receiving power and data from a power or RFID source. The device 300 may also include one or more output network interfaces 310 for communicating with other devices. The device 300 may also include input/output 340 representing devices which allow for user interaction with a computer (e.g., display, keyboard, mouse, speakers, buttons, etc.).

One skilled in the art will recognize that an implementation of an actual device will contain other components as well, and that FIG. 3 is a high level representation of some of the components of such a device for illustrative purposes. It should also be understood by one skilled in the art that the devices depicted and described with respect to FIG. 1 may be implemented on a device such as is shown in FIG. 2.

While the disclosed invention has been taught with specific reference to the above embodiments, a person having ordinary skill in the art will recognize that changes can be made in form and detail without departing from the spirit and the scope of the invention. The described embodiments are to be considered in all respects only as illustrative and not restrictive. All changes that come within the meaning and range of equivalency of the claims are to be embraced within their scope. Combinations of any of the methods, systems, and devices described hereinabove are also contemplated and within the scope of the invention.

What is claimed is:

1. A theft-avoidance bicycle and lock, comprising:
a frame structure;
a locking component physically associated with the frame structure;
an anchoring member having two ends, a first end connectable to the frame structure via the locking component and a second end connectable to a fixture;
a vibration detector, which includes a gyroscope; and
electric circuitry included in the locking component which, when activated, generates an electrical current having a voltage sufficient to induce an electric shock to a person attempting to break the anchoring member;
the electric circuitry is activated to generate the electric shock to the person after:
the locking component is physically engaged to the bicycle and the anchoring;
vibration is detected by the vibration detector when the bicycle is parked; and
a user of the bicycle is outside a vicinity of the bicycle as determined by an associated radio-frequency identification system.

2. The theft-avoidance bicycle and lock of claim 1, wherein the electric circuitry is deactivated when the user is detected within the vicinity of the bicycle.

3. The theft-avoidance bicycle and lock of claim 1, wherein said radio-frequency identification system comprises:
a radio-frequency transmitter disposed on the bicycle; and
a radio-frequency receiver carried by a user of the bicycle.

4. The theft-avoidance bicycle and lock of claim 1, wherein the electric circuitry notifies the user via a smart device instantaneously when the bicycle is being moved.

5. The theft-avoidance bicycle and lock of claim 4, wherein the notification comprises a measurement of the electrical current.

6. The theft-avoidance bicycle and lock of claim 1, wherein the electric circuitry remains deactivated when the bicycle is in being used by the user.

7. A method of deterring theft of a bicycle, the method comprising the following steps:
providing a bicycle with framework having an electrical circuit disposed therein;
detecting, using an accelerometer disposed on the bicycle, that the bicycle is being moved;
determining, using a radio-frequency transmitter disposed on the bicycle, that an associated radio-frequency identification tag associated with a user is not within a vicinity of the bicycle; and
generating an electrical current throughout the framework of the bicycle, wherein the electrical current has a voltage sufficient to inflict slight pain on a human.

8. The method of claim 7, further comprising a step of:
notifying the user when an electrical current has been generated.

9. The method of claim 8, wherein the notification is a text message sent to a mobile device associated with the user.

10. The method of claim 9, wherein said notification comprises a measurement of the electrical current generated.

11. A theft-avoidance bicycle against theft when being parked, comprising:
a frame structure;
a locking component physically associated with the frame structure;
an anchoring member having two ends, a first end connectable to the frame structure via the locking component and a second end connectable to a fixture, which includes a light post;
a vibration detector, which includes a gyroscope;
a warning signal to indicate that the bicycle is being charged and can cause damage to a person who touches the bicycle; and
an electric circuitry included in the locking component which,
when activated generates the warning signal is displayed and an electrical voltage waveform which has a relatively high voltage that can induce an electric shock to a person who is trying to misappropriate the bicycle by attempting to break the anchoring member by means including tweezers;
the electric circuitry would be activated and its associated circuit should be in a closed circuit so that a current can be applied to generate the electric shock to the person who is trying to misappropriate the bicycle, when all following conditions are met:
the locking component is physically engaged to the bicycle, which suggests that the bicycle is being parked and the anchoring member is being connected to the fixture;
vibration is being detected by the vibration detector or gyroscope unexpectedly, which suggests that the bicycle is possibly being misappropriated by someone improperly when parked; and
a user of the bicycle is outside vicinity of the bicycle, which eliminates a possibility that the vibration detected is caused by the user; determination of the user being outside the vicinity of the bicycle can be achieved by using radio frequency emitters and tags;
the electric circuitry would be deactivated and its associated circuit should be switched from a closed circuit to an open circuit to prevent the electric shock from applying to the user of the bicycle mistakenly, when following condition is met:
when the user is found within the vicinity of the bicycle, because it would be unnecessary to protect the bicycle from stolen if the user is within a certain distance from the bicycle, while otherwise might cause the electric shock to the user of the bicycle; and
the electric circuitry would notify the user via a smart device instantaneously when the parked bicycle is being moved when the move is detected by the vibrator detector or gyroscope, the notification includes how much current flows out, which is a good indicator as to whether the move is caused by a human being when considering resistance of the underlying object; and
the electric circuitry would remain deactivated and its associated circuit would remain in an open circuit to prevent the electric shock from applying to the user of the bicycle mistakenly, when the bicycle is still in use by the user so that the user would be safe to use the bicycle.
